(19) United States
(12) Patent Application Publication
(10) Pub. No.: US 2011/0236173 A1
(43) Pub. Date: Sep. 29, 2011

(54) System, apparatus, and method for supporting a vehicle for underbody servicing

(76) Inventors: David E. Jarvis, Summerville, SC (US); Stephen Robert Nadolski, Charleston, SC (US); Charles K. Hughes, JR., Summerville, SC (US); David G. Farris, Summerville, SC (US)

(21) Appl. No.: 12/801,478

(22) Filed: Jun. 10, 2010

(51) Int. Cl. B66F 3/00; F16M 9/00

(52) U.S. Cl. 414/800; 248/675

(57) ABSTRACT

A system for supporting vehicles above a ground surface to provide access to an underbody, includes four vertical supports each having a vertical support member. A first elongated beam member has a central portion configured for connecting to a vehicle frame front part, the first beam member having opposed ends. A second elongated beam member has a central portion configured for connecting to a vehicle frame rear part, the second beam member having opposed end portions. The first beam central portion includes means for releasably attaching the first beam member to the towing/tie-down structure on the vehicle frame front part, and the second beam member central portion includes means for releasably attaching the second beam member to the towing/tie down structure on the vehicle frame rear part. Each of the first beam member opposed ends and the second beam member opposed ends is configured with a recess to releasably receive a respective support member to restrain relative movement among all the support members in a horizontal plane.

### BACKGROUND

1. Field of the Invention

The present invention relates to systems, apparatus, and methods of supporting vehicles above the ground for underbody servicing. More particularly, the present invention relates to systems, apparatus, and methods for safely supporting heavy vehicles, such as military vehicles in theater, for extended periods of time for underbody servicing.

2. Description of the Prior Art

There typically is limited apparatus available to support heavy vehicles in a military theater—overhead cranes of the appropriate tonnage do not exist in theater. The old method of supporting the vehicles for any underbody service work was unsafe and inefficient. It involved positioning the vehicle on air bottle jacks. Due to limited mounting points, the jacks typically were positioned close to the center line of the truck. Also, the jacks were not tied together to form an integrated primary support. This caused the vehicle to be unstable and unbalanced, increasing the likelihood of falling.

Automotive type lifts such as column-hydraulic or pneumatic lifts will pick up a truck but are not designed to hold it for an extended period. For example, welding repairs may require the vehicle be held in an elevated position for at least 48 hours once pieces are welded, in order to perform weld inspection.

Moreover, column lifts typically engage wheel/axle assemblies to lift the vehicle, which precludes any axle or suspension work or upgrades. Also, while column lifts have been used with beams to raise the vehicle by central parts of the frame, this is not an option for vehicles with V shaped hull bottoms. Moreover, column lifts are still relatively unsafe for long term support, due to potential failures/leakage of the hydraulic/pneumatic circuits.

### SUMMARY OF THE INVENTION

A system is disclosed for supporting vehicles above a ground surface to provide access to an underbody, the vehicle having a front, a rear, and opposed transverse sides, the vehicle also having a frame extending between the front and the rear. The system includes four vertical supports each having a vertical support member, a first elongated beam member having a central portion configured for connecting to a vehicle frame front part, the first beam member having opposed ends, and a second elongated beam member having a central portion configured for connecting to a vehicle frame rear par. The second beam member has opposed ends. The first and second beam members are sized and configured to together support at least the entire weight of the vehicle as applied through the front and rear frame parts to respective first and second beam central portions.

The first beam central portion includes means for releasably attaching the first beam member to the vehicle frame front portions, and the second beam member central potion includes means for releasably attaching the second beam member to the vehicle frame rear portion. Also, each of the first beam member opposed ends and the second member opposed ends is configured to releasably receive a support member to restrain relative movement among all the support members in a horizontal plane.

Apparatus is disclosed for supporting a vehicle above the ground on spaced apart movable vertical supports for access to a vehicle underbody, the vehicle having a longitudinally front and rear, and opposed transverse sides, and a frame extending between the front and rear. The movable vertical supports each have a vertically directed support element. The system includes: a first elongated beam member having a central portion configured for connecting to a vehicle frame front part, the first beam member having opposed ends, and a second elongated beam member having a central portion configured for connecting to a vehicle frame rear part, the second beam member having opposed end portions. The first and second beam members are sized and configured to together support at least the entire weight of the vehicle as applied through the front and rear frame parts to the respective first and second beam central portions. The first beam central portion includes means for releasably attaching the first beam member to the vehicle frame front part, and the second beam member include means for releasably attaching the second beam member to the vehicle frame rear part. Each of the first beam member opposed ends and the second beam member opposed ends are configured to releasably receive a respective support member to restrain relative movement therebetween in a horizontal plane.

A method of lifting and supporting a vehicle above a ground surface on four horizontally movable vertical supports for access to an underbody is disclosed, the vehicle having a front, a rear, opposed transverse sides, and a frame extending between the front and the rear. The method includes providing first and second beam members transversely beneath a front portion of the frame and a rear portion of the frame, respectively, the first and second beam members having respective ends, releasably attaching each of the first and second beam members to the front and rear frame portions, respectively, elevating the first and second beam members in coordination to a desired height above the ground surface, positioning each of the four movable supports beneath a respective one of the first beam member ends and second beam member ends, and engaging the movable supports with the respective ends. The engaging includes integrating the four movable supports through the beams and the vehicle frame to prevent independent horizontal movement of each support relative to all the other supports.

Additional features and advantages of the invention will be set forth in part in the description which follows, and in part will be obvious from the description, or may be learned by practice of the invention. The invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIGS. 1A and 1B are front and rear views, respectively, of a vehicle supported by an embodiment of the vehicle support system and apparatus in accordance with the present invention;

FIGS. 2A-2C are perspective, top, and side views, respectively, of a front beam member of the system and apparatus depicted in FIGS. 1A and 1B;

FIGS. 3A-3C are perspective, top, and side views, respectively, of a rear beam member of the system and apparatus depicted in FIGS. 1A and 1B;

FIGS. 4A and 4B are perspective and bottom details, respectively, of the beam end assembly of the front end and rear beam members depicted in FIGS. 2A-2C and 3A-3C;

FIG. 5 is a perspective view of the engagement of a vertical support member with the beam end assembly of FIGS. 4A and 4B;

FIG. 6 is a detail of the replaceable mounting unit shown in FIG. 2A attaching the front beam member to the vehicle front towing/tie-down structure; and

FIG. 7 shows a variation of the front beam and rear beam shown in FIG. 2A and FIG. 3A, having only a replaceable yoke assembly unit for attaching to the vehicle towing/tie-down structure.

### DESCRIPTION OF DISCLOSED EMBODIMENTS

Reference will now be made in detail to the present embodiments of the invention examples of which are illustrated in the accompanying drawings. Wherever possible, the same reference numbers will be used throughout the drawings to refer to the same or like parts.

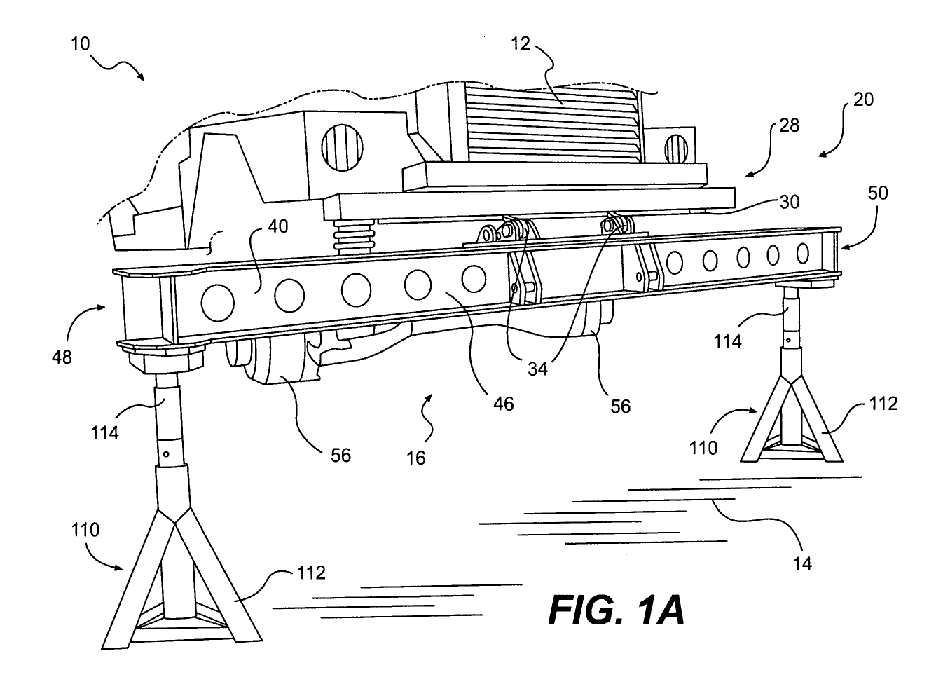

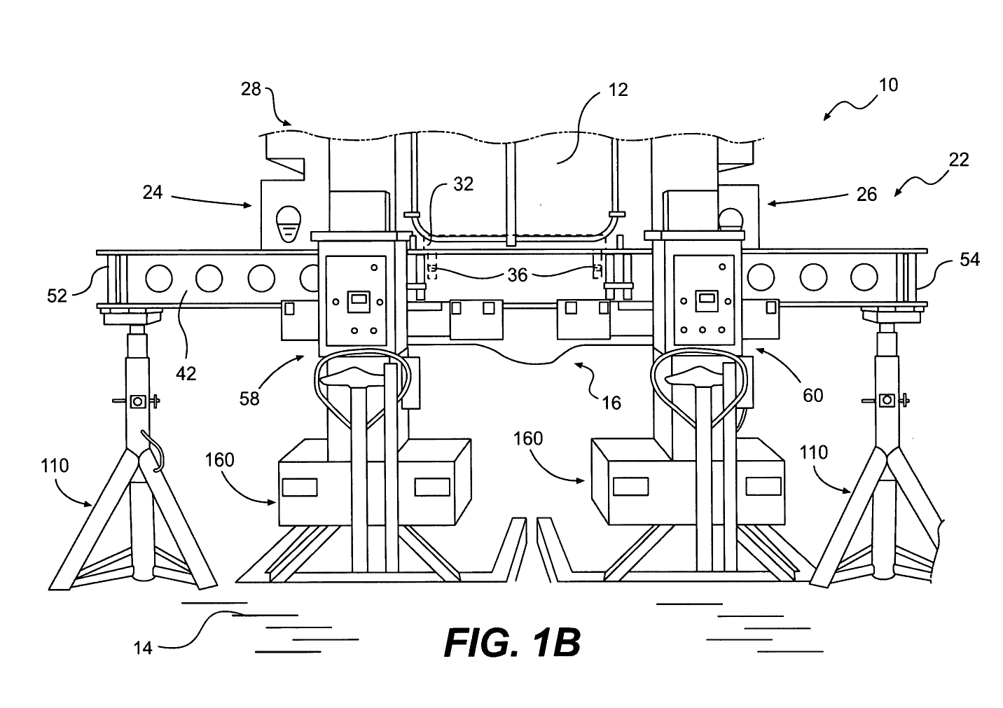

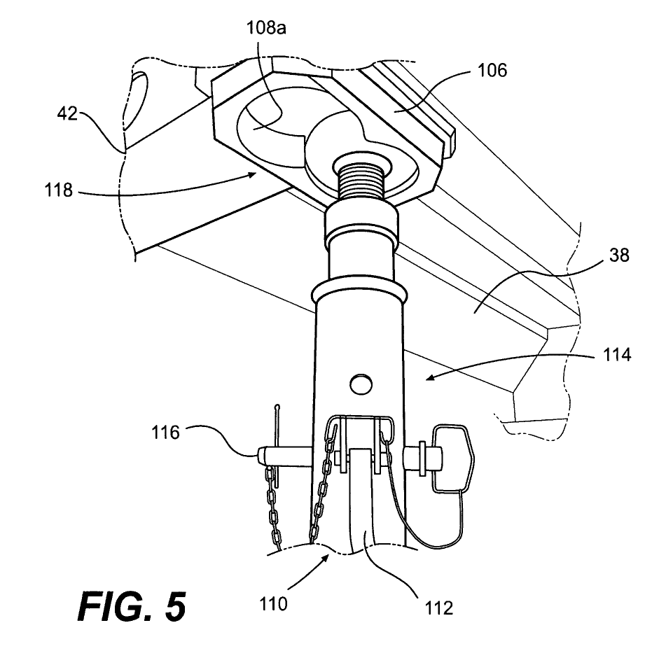

With initial reference to FIGS. 1A and 1B, an embodiment 10 of the vehicle support system of the present invention is shown supporting a vehicle 12 above the ground 14, such as a concrete floor, to allow access to the vehicle underbody 16, such as for maintenance, repair, and/or replacement of vehicle components. Vehicle 12 has a front 20, a rear 22, and opposed transverse sides 24, 26. Vehicle 10 also has a frame 28 which may include, for the purposes of the present disclosure, parts such as, for instance, front and rear members 30, 32 from which front and rear vehicle towing/tie down structure 34, 36 are typically fixedly mounted. See FIGS. 1A and 1B. For purposes of the following discussion the towing/tie down structure such as, for example, 34, 36 are considered part of the front and rear frame parts. Vehicle 12 also may include a “V”-shaped hull or hull portions, such as V-hull 38 extending longitudinally along, and supported by, frame 28. See FIG. 5.

Depicted in FIGS. 1A and 1B is an armored military vehicle used for transporting personnel and/or equipment, but the present invention is not restricted to military vehicles and/or armored vehicles. Rather, the vehicle exemplary of vehicles ordinarily requiring heavy duty cranes for long term (e.g. one or more days) support above ground for extended underbody work, necessitating positive mechanical supporting structure for safety, as opposed to support via hydraulic/pneumatic lifting systems. However, the present invention in its broader aspects, does not preclude use of heavy duty cranes and/or hydraulic/pneumatic lifting devices to move the vehicle between ground and a raised position including short term support until other components of support system 10, namely static vertical supports 110, are in place as will be evident from the following discussion.

In accordance with the present invention, as broadly described herein, the vehicle support system includes first and second elongated beam members configured for connecting to respective front and rear frame parts of the vehicle to extend transversely of the front-rear direction. As embodied herein and with continued reference to FIGS. 1A and 1B, first and second elongated beams 40 (FIG. 1A) and 42 (FIG. 1B) are attached to vehicle front and rear towing/tie-down structure 34, 36 at respective beam central portions 44, 46 by means to be discussed hereinafter. When connected, beam members 40, 42 extended transversely toward vehicle sides 24, 26, and may be sized to extend beyond the respective vehicle sides a distance sufficient to allow access to any proximate wheels or tracks and associated brake, housing, and/or suspension components. In the disclosed embodiment, opposed first beam member ends 48, 50 and opposed second beam ends 52, 54 extend transversely about two feet beyond the positions of front wheel housing 56 depicted (FIG. 1A) and rear wheel hubs 58, 60 (FIG. 1B), allowing unobstructed access.

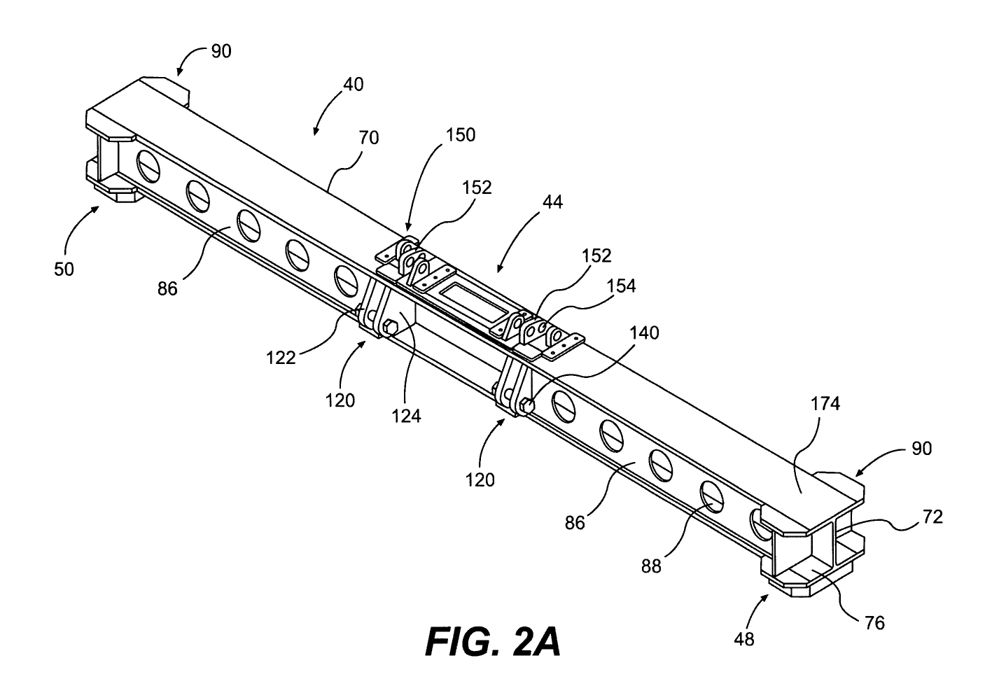

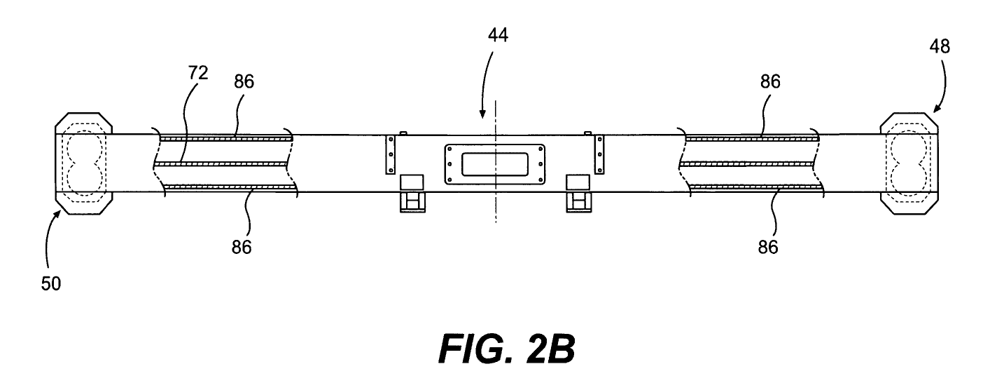

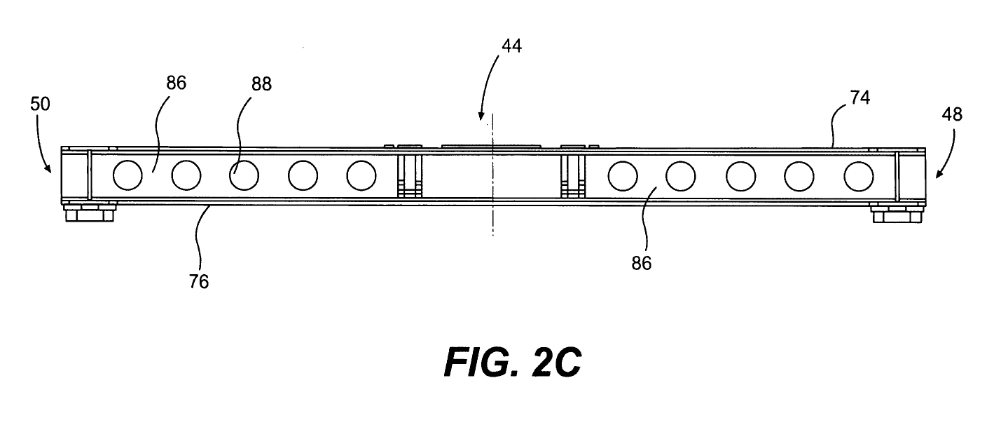

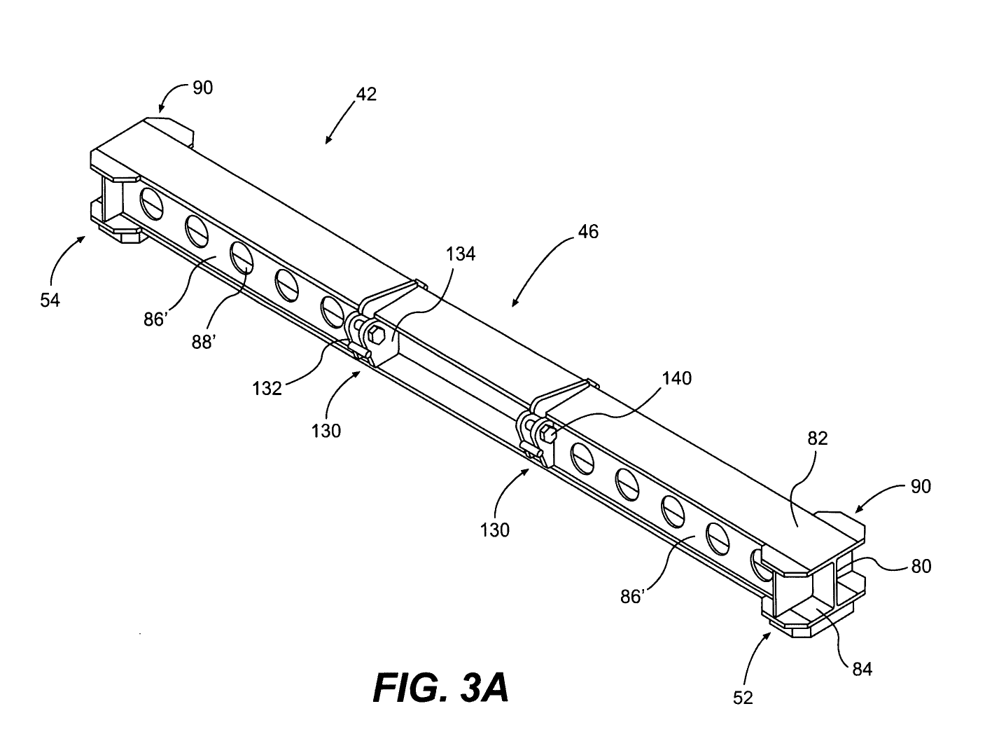

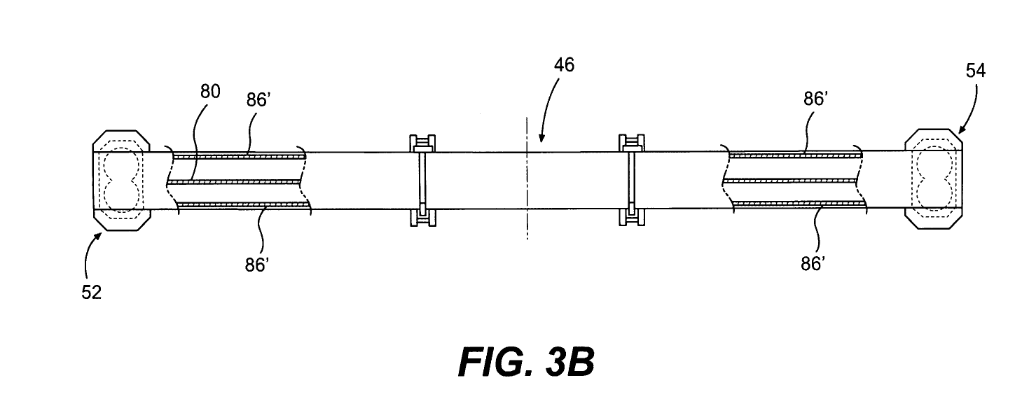

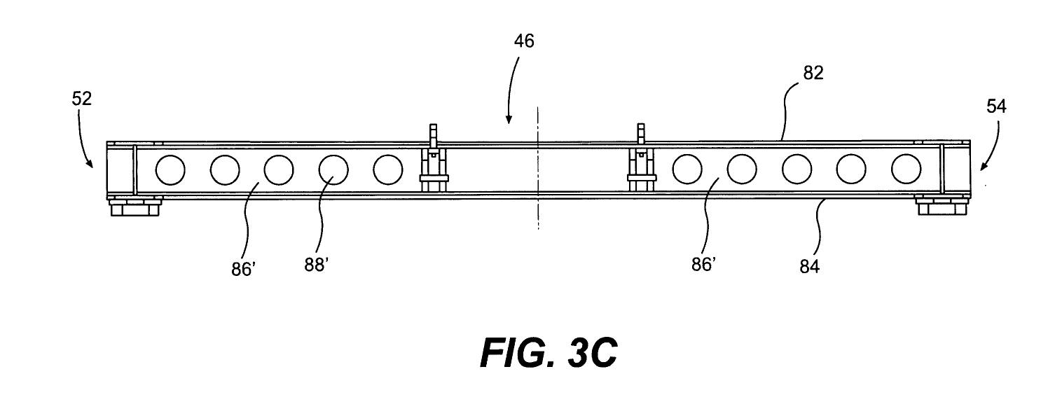

As configured in the embodiment depicted in FIGS. 1A and 1B, and as best seen in FIGS. 2A-2C and 3A-3C, each of first and second beam member 40, 42 includes an elongated beam extending between the respective beam ends, such as beam 70, having a web plate 72 and top and bottom flanger 74, 76, of first beam member 40, and beam 78, with a web plate 80, and top and bottom flanger 82, 84 of second beam member 42. The respective beam components 70 and/or 78 may be further strengthened by elongated plates fixed between the top and bottom beam flanger parallel to and spaced from the web plate between the central and end portions of the respective beam. For example, and as best seen in FIGS. 2B and 2C, first beam member 40 of system 10 includes four plates 86 fixed between beam top flange 74 and bottom flange 76, spaced from beam web plate 72. Each plate 86 extends between central beam portion 44 and opposed first beam member ends 48, 50. Plates 86 may have apertures 88 to decrease weight without a significant decrease in bending stiffness (modulus), as one skilled in the art would appreciate. Similarly, and as best seen in FIGS. 3A-3C, second beam member 42 may have four plates 86′ (preferably with apertures 88′) extending between central second beam member portion 46 and opposed second beam ends 52, 54. Plates 86′ are parallel to and spaced from beam web 80, and are fixed to top and bottom beam flanger 82, 84.

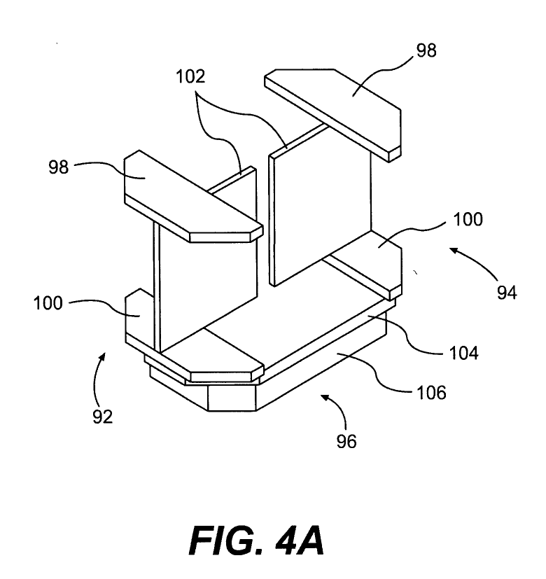

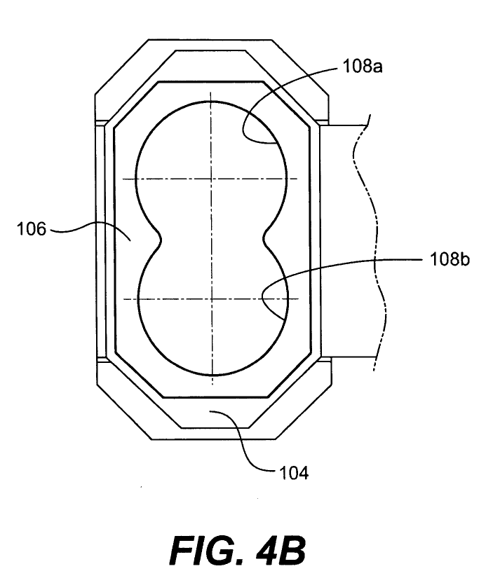

It also may be preferred to further strengthen the first and second beam member by providing respective beam end assemblies, to increase the torsional rigidity, and also to facilitate engagement with vertical supports 110. As embodied herein, and as best seen in FIGS. 4A and 4B, each beam end assembly 90 is generally rhomboid-shaped with opposed legs 92, 94 and base 96 joining the legs. Each of legs 92, 94 is a beam like structure having top and bottom flanger 98, 100 and a web 102. The components of legs 92, 94 are configured to nest with, and perpendicular to, beam ends 48, 50 and 52, 54, as best seen in FIGS. 2A and 3A. Stacked tie plates 104, 106 are provided at base 96 to join legs 92, 94. Bottom tie plate 106 includes two partially separated apertures forming, with upper tie plate 104, recesses 108a, 108b for receiving and horizontally constraining vertical support element 114 of a respective vertical support 110, as will be described henceforth. Upper tie plate 104 is configured to abut received vertical support elements 114 and transfer vertical support forces from the support member to the respective beam member. The lug and base components of beam end assemblies 90 are fixedly joined together and to the respective beam member end such as by welding to provide an integral beam member structure.

While support plates 104, 106 or their equivalents may be used alone with beam members 40, 42, that is, without reinforcing legs 92,94, and still come within the scope of the present invention in its broadest aspects, it may be preferred to use the disclosed rhomboid-shaped beam end assembly for increased beam tortional stiffness.

Further in accordance with the present invention, and as broadly described herein, the vehicle support system include four static vertical supports each having a vertically directed support element. As embodied herein, and with reference again to FIGS. 1A and 1B, four jack-stand type vertical supports 110 are depicted each having a tripod base 112 movable horizontally along the ground 14 when not supporting a vertical load. Each vertical support includes a vertical support member 114 extending from base 112 for engaging a recess 108a or 108b in a respective beam end assembly. See FIG. 5. The height of vertical support member 114 above ground can be adjusted by locking pins and holes combinations 116 in a base 112 and by screw engagement 118 between base 112 and vertical support member 114. Jack stands of the type described and suitable for use in the support system 10 for vehicles of the weight of the vehicle are available from commercial sources

As one skilled in the art would understand, though movable when not engaged with beam member 40, 42, vertical supports 110 are locked or integrated together as a single support platform once the vertical support members 114 are received in recesses 108a (or 108b) and are loaded, and thus constrained against independent horizontal movement. That is, the four vertical supports are integrated through the beam members 40, 42 and vehicle frame 28 as a result of both beam members being securely but releasably attached to frame 28 via lugs 34, 36 in vehicle support system 10, as will now be discussed.

Specifically, and with reference to FIGS. 2A-2C and 3A-3C, first and second beam member 40, 42 include respective pairs of yoke assemblies 120, 130 fixed to and extending from the central portions 44, 46 of beam members 40, 42. The respective yoke assembly pairs are spaced apart along the respective central beam member portions a distance equal to the separation distance of the front and rear tie down/towing structure 34, 36 so that the structure can be securely captured in the individual yokes 122, 132 using suitable bolt and nut assemblies 140 to rigidly but removably connect, and thus integrate, frame 28 with beam members 40, 42. Moreover, the individual yokes 122, 132 can be formed from plate members 124 and 134, respectively that are nested in, and permanently attached perpendicular to, the respective beams 70, 78, such as by welding, as depicted in FIGS. 2A-2C and 3A-3C. While other releasably attaching means may provide the desired functions, and thus come within the scope of the present invention it its broadest aspects, the use of e.g. yoke assemblies 120, 130 with bold/nut assemblies 140 to capture and securely attach to existing vehicle front and rear tie down/towing structure 34, 36 may together comprise a preferred means as the yoke assemblies are fixedly attached to the respective beams.

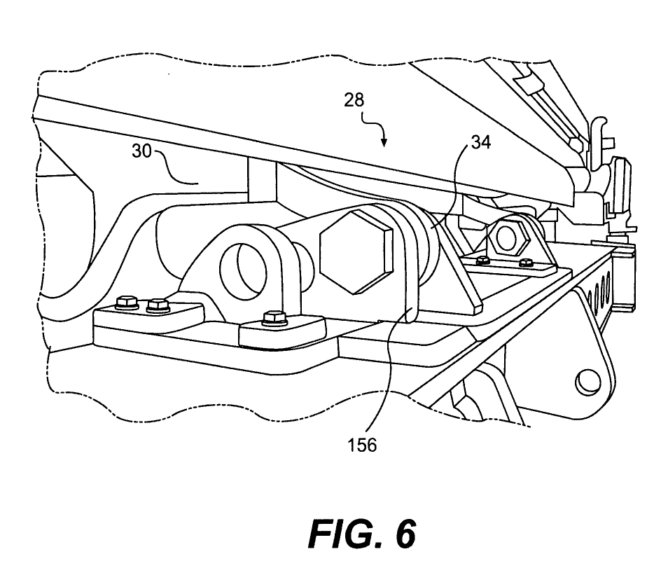

Still further, and with reference to FIGS. 2A and 6, one or both of beam members 40, 42 may be provided with adaptor unit 150 (only beam member 40 is shown with unit 150 in the drawings) each comprising another pair of spaced-apart yoke assemblies 152 with associated yokes 154 and bolt/nut assemblies 156 (see FIG. 3A) to accommodate vehicles having different support structure spacings. Also, adaptor unit 150 may be mounted to the top of beam member 40 (or 42, not shown) by removable mounting plate 156.

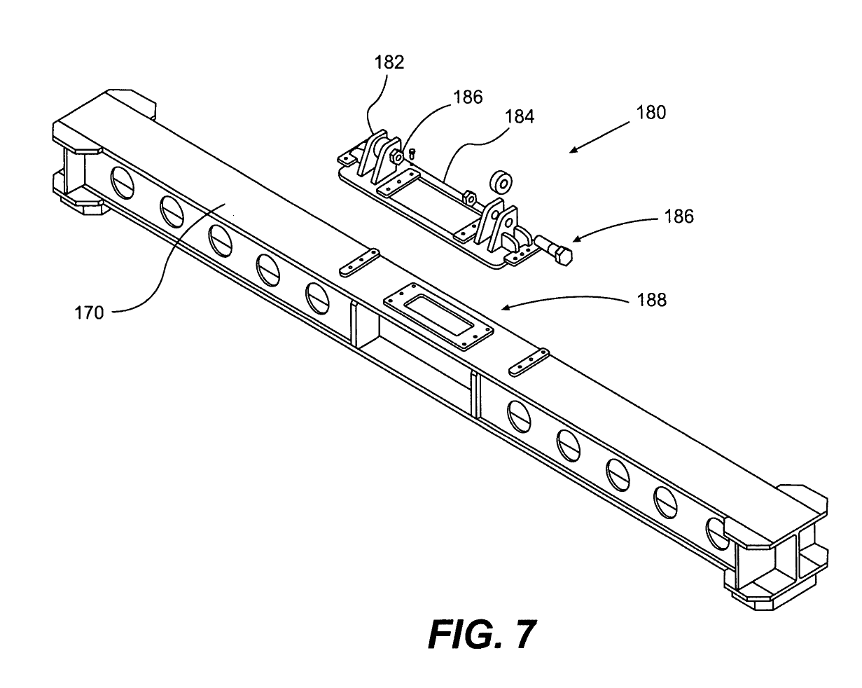

The embodiment of beam member 40, 42 depicted in FIGS. 2A-2C and 3A-3C contemplates differences in the support structure spacing and/or presentation in the vehicle front versus the vehicle rear. However, if the spacings and presentations are identical, then beam members 40, 42 may also be identical, a system using two such identical beam members also is considered within the scope of the present vehicle support invention. Similarly, it may be convenient to remove sets of yoke assemblies 120, 130 from sides of beam member 40 or 42, to provide a simple generic beam member similar to beam 170 (as shown in FIG. 7). These latter constructions would promote interchangeability even in face of different front-rear tie-down/towing support structure spacings and/or presentations, and a pair of such generic beam members is also considered within the scope of the present system invention.

Furthermore, it may be preferred to provide a system having essentially identical beam members for the vehicle front and rear but having only interchangeable adaptor units similar to unit 150 shown in FIG. 2A. With reference to FIG. 7, generic beam member 170 is depicted with changeable adaptor unit 180 having spaced apart yoke assemblies 182 on mounting plate 184. Also shown are bolt assemblies 186 for connecting to the individual yokes, and a suitably configured seat 188 on beam member 170, for receiving mounting plate 184. As one skilled in the art would understand from the present disclosure, a support system would utilize a pair of “generic” beam member 170 and a pair of adaptor units 180, which units may have different yoke structure spacings for the front and rear of the vehicle to be supported. The generic beams and adaptor units could be provided in kit form.

In operation, a method of employing the disclosed vehicle support system begins with positioning the first and second beam members 40, 42 beneath the vehicle front and rear, and raising them to provide registration of the respective yoke assemblies (120, 130, or 182) with respective vehicle towing/tie-down structures 34, 36. The beam members are then securely attached to the towing/tie-down structure, and thus to frame 28, using bolt/nut assemblies 140 (or 186).

Next, beam members 40, 42, with the secured vehicle 12, are elevated in a coordinated fashion to a level where the four vertical supports 110 can be positioned beneath the respective beam member ends 48, 50 and 52, 54. While various lifting means can be employed, it may be preferred to use a plurality of column-type fork-lifts for each beam member, such as column-lifts 160 shown engaged with beam member 42 in FIG. 1B (two per beam member), as the flat bottom beam flanger 76 and 84 are readily accessible for engagement by the lifting forks. The column, which may be battery powered, can be independently controlled provide synchronized lifting, to maintain the vehicle in a level orientation, and prevent sliding/tripping. Column lifts available from commercial sources are suitable for vehicles of a similar weight class.

Next, the vertical support members 114 of support 110 can be engaged with the respective beam end recess 108a or 108b by coordinated lowering of beam members 40, 42 using the lifting devices of 160 and/or upwardly adjusting the respective vertical support members 114. As one skilled in the art would appreciate, return of vehicle 12 to ground support with support system 10 is accomplished by reversing the above sequence.

Other embodiments of the invention will be apparent to those skilled in the art from consideration of the specification and drawings and practice of the invention disclosed herein. It is intended that the specification and drawings be considered as exemplary only, with a true scope and spirit of the invention being indicated by the following claims.

What is claimed is:

1. Apparatus for supporting a vehicle above the ground on spaced apart movable vertical supports for access to a vehicle underbody, the vehicle having a longitudinally front and rear and opposed transverse sides, the vehicle also having a frame extending between the front and the rear, the movable vertical supports each having a vertically directed support element, the system comprising:
a first elongated beam member having a central portion configured for connecting to a vehicle frame front part, the first beam member having opposed ends;
a second elongated beam member having a central portion configured for connecting to a vehicle frame rear part, the second beam member having opposed end portions, the first and second beam members being sized and configured to together support at least the entire weight of the vehicle as applied through front and rear frame parts to the respective first and second beam central portions;
wherein the first beam central portions includes means for releasably attaching the first beam member to the vehicle frame front part;
wherein the second beam member includes means for releasably attaching the second beam member to the vehicle frame rear part; and
wherein each of the first beam member opposed ends and the second beam member opposed ends is configured to releasably receive a respective support member to restrain relative movement therebetween in a horizontal plane.

2. The apparatus as in claim 1, wherein the vertical supports are jack stands each having a vertical support member; and wherein each of the first beam member and second beam member opposed ends includes a beam end assembly with a bottom member having a recess configured for supportingly receiving and horizontally constraining the support member.

3. The apparatus as in claim 1, wherein the first and second beam members are sized to extend transversely beyond the respective vehicle sides a distance sufficient to permit access to proximate vehicle wheel assemblies.

4. The apparatus as in claim 1, wherein the respective central portions of the first and second beam member have a bottom surface configured to be engaged by the forks of one or more lifting devices.

5. The apparatus as in claim 1, wherein the vehicle has towing/tie down structure attached to the front and rear frame portions, the structure having apertures, and wherein the first and second releasably attaching means include respective yoke assemblies attached to the first and second beam members and bolt/nut assemblies for releasably connecting the yoke assemblies to a respective towing/tie-down structure.

6. The apparatus as in claim 1, wherein one or both of the first and second means for attaching includes a changeable attachment unit attachment, the attachment unit having yoke assemblies each bolt/nut assemblies being for releasably attaching to towing/tie-down lugs of the vehicle.

7. The apparatus as in claim 1, wherein the vehicle has a V-shaped hull, and wherein the first and second beam members attach to the front and rear frame parts forward and backward of the V-hull, respectively.

8. The apparatus as in claim 2, wherein each of the first and second beam end assemblies is generally rhomboid-shaped; and wherein the assemblies are fitted beam sections fixedly attached perpendicular to the beam members.

9. The apparatus as in claim 1, wherein each of the first and second beam members includes a central beam having a web extending along its entire length; and wherein the portion of each of the first and second beam members extending between the central portions and the respective beam ends are reinforced with opposed elongated plates fixed parallel to, and spaced from, the web of the respective central beam.

10. The apparatus as in claim 9, wherein the means for attaching the first beam member and/or the means for attaching the second beam member include yoke assemblies with spaced apart flange members each extending perpendicular to, and fixed to, the web of the respective central beam, each flange member also abutting an end of a proximate elongated reinforcing plate.

11. A system for supporting vehicles above a ground surface to provide access to an underbody, the vehicle having a front, a rear, and opposed transverse sides, the vehicle also having a frame extending between the front and the rear, the system comprising:
four vertical supports each having a vertical support member;
a first elongated beam member having a central portion configured for connecting to a vehicle frame front part, the first beam member having opposed ends;
a second elongated beam member having a central portion configured for connecting to a vehicle frame rear part, the second beam member having opposed end portions, the first and second beam members being sized and configured to together support at least the entire weight of the vehicle as applied through the front and rear frame parts to respective first and second beam central portions;
wherein the first beam central portion includes means for releasably attaching the first beam member to the vehicle frame front part;
wherein the second beam member central potion includes means for releasably attaching the second beam member to the vehicle frame rear part; and
wherein each of the first beam member opposed ends and the second beam member opposed ends is configured to releasably receive a respective support member to restrain relative movement among all the support members in a horizontal plane.

12. The system as in claim 11, further including a plurality of controllable lifting devices, the first and second beam members being configured to be engaged by the lifting devices.

13. The system as in claim 12, wherein the vertical supports are jack stands, and the vertical lifting devices are column lifts.

14. The system as in claim 11 in kit form.

15. The system as in claim 12 in kit form.

16. The system as in claim 11, wherein has towing/tie-down structure depending from the front and rear frame parts, and wherein the releasably attaching means includes one or more pairs of yoke assemblies and bolt/nut assemblies for securely attaching to the structure.

17. Method of lifting and supporting a vehicle above a ground surface on four horizontally movable vertical supports for access to an underbody, the vehicle having a front, a rear, and opposed transverse sides, the vehicle also having a frame including front and rear parts, the method comprising:
positioning first and second beam members transversely adjacent the front and rear parts of the frame, respectively, the first and second beam members having respective opposed ends;
releasably attaching each of the first and second beam members to the front and rear frame parts, respectively;
elevating the first and second beam members with the attached vehicle in coordination to a desired height above the ground surface;
positioning each of the four movable supports beneath a respective one of the first beam member ends and second beam member ends; and
engaging the movable supports with the respective ends, wherein the engaging includes integrating the four movable supports through the beams and the vehicle frame to prevent independent horizontal movement of each support relative to the other supports.

18. The method as in claim 17, wherein the vehicle includes front and rear towing/tie-down structure each having an aperture, and wherein the releasably attaching includes bolting the structure to respective yoke assemblies provided in center portions of the first and second beam members.

19. The method as in claim 17, wherein each vertical support has vertically extending support member, and wherein the engaging includes receiving each of the support members in a respective mating recess formed on a bottom portion of a respective one of each first and second beam ends.

20. The method as in claim 17, wherein the coordinated lifting is carried out using a plurality of column lifts.
